(19) United States
(12) Patent Application Publication
(10) Pub. No.: US 2004/0076000 A1
(43) Pub. Date: Apr. 22, 2004

(54) Carrying case and method for making same

(76) Inventor: Robert B. Thorp, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 10/274,567

(22) Filed: Oct. 18, 2002

(51) Int. Cl. F21V 33/00

(52) U.S. Cl. 362/154; 362/156

(57) ABSTRACT

A carrying case such as a backpack includes at least one visible exterior surface and an opposite interior surface. A child-appealing graphic image is disposed on a portion of the visible surface, and a plurality of light emitting diodes are attached to the visible surface at predetermined locations on the graphic image. A printed circuit board having driver circuitry thereon is disposed intermediate the exterior graphic image and the opposite interior surface. A battery module is fixedly coupled to the interior surface and electrically coupled to the driver circuitry to cause the light emitting diodes to blink. A switch (e.g. a tilt switch) is coupled between the battery module and the printed circuit board for controlling the application of power to the driver circuitry.

### TECHNICAL FIELD

This invention relates generally to a bag or case of the type having at least one strap and configured to be worn over at least one shoulder (e.g. a backpack) or around the waist (e.g. a waistpack) of a user. More particularly, this invention relates to a backpack, waistpack, and the like that includes a graphic image thereon and a plurality of light-emitting-diodes (LEDs) that coordinate with the graphic image and can be seen from a significant distance.

### BACKGROUND OF THE INVENTION

With the increasing popularity of backpacks, waistpacks, etc., and the use thereof by school-age children for carrying schoolbooks, papers, and other items, the visibility of modern backpacks, especially from behind, has become a concern for parents. For example, most backpacks are made of non-reflective or dark colors, and may even cover the child from neck to legs, decreasing visibility of the child especially during evening hours. The ability to see children has become increasingly important during the loading and unloading of buses, walking home along busy streets, and during after-hours school activities.

This problem has led to the use of illumination devices integrally coupled to a backpack or waistpack so as to increase their visibility, and therefore that of its user. For example, U.S. Pat. No. 5,572,817 issued Nov. 12, 1996 entitled “Multi-color Electro-Luminescent Light Strip and Method of Making Same” and U.S. Pat. No. 5,836,671 issued Nov. 17, 1998 entitled “Backpack or Waistpack E.L. Lighting Arrangement” disclose a backpack that is equipped with an electro-luminescent lighting strip on an exposed or visible surface thereof. The device, however, is undesirable for several reasons. For example, the device is not cost effective because the lighting arrangement operates through an AC/DC power converter. Furthermore, the light produced may not be readily seen during daylight hours. In addition, the device utilizes a circuit board that may contain lead, and the user may be exposed to undesirable lead solder or a mercury motion switch, both of which may be harmful to children.

U.S. Pat. No. 6,341,874 issued Jan. 29, 2002 entitled “Combination Safety Strobe Device” discloses a combination safety strobe device that is visible from 360 degrees and attaches to a backpack, pet collar, key chain, or article of clothing. This is undesirable for child-safety applications because the device must be attached to the backpack or other article and can become unattached either accidentally or intentionally by the child. A switch is required to turn the light on, and a child may forget to do so. The device is easily broken if dropped. Finally, the design is not appealing to young children, and therefore, they will resist its use.

Many currently used safety lighting arrangements employ only red lights, and it has been shown that blue, yellow, and/or white lights may be more effective. For example,. police and fire departments utilize highly visible blue, red, and yellow lighting for emergency lighting applications. Thus, known lighting arrangements fail to provide adequate, convenient, and attention-getting safety lighting for children in both daylight and evening hours when children are most vulnerable. In addition, the current state of the art fails to provide such lighting in a manner that is appealing and suited specifically to young children.

Thus, there exists a need for a safety-lighting backpack that is highly visible (over 150 feet) during both daylight and evening hours, is sturdy, durable, and has a permanently attached multicolored safety-lighting system on the backpack that is appealing to children and does not require them to remember to turn it “on” when safety lighting is needed. The device should be light-weight, water resistant during inclement weather, free of mercury and lead, safe to operate, and difficult to detach or loose. It should be fun and appealing to children so that they are more apt to wear it at all times; i.e. it should not look like a safety device.

### BRIEF SUMMARY OF THE INVENTION

According to an aspect of the invention there is provided a carrying case that comprises a first panel having a first normally visible surface and a second normally hidden surface opposite the first normally visible surface. A graphic image is disposed on the first normally visible surface, and a plurality of light emitting diodes are attached to the first normally visibly surface at predetermined locations on the graphic image.

According to a further aspect of the invention there is provided a carrying case of the type that includes at least one enclosure. At least a section of the one enclosure includes a visible exterior surface and an opposite interior surface. A graphic image is disposed on the exterior surface, and a plurality of light emitting diodes are attached to the exterior surface at predetermined locations on the graphic image.

According to a still further aspect of the invention there is provided a safety backpack of a type which includes at least one enclosure that comprises a visible exterior surface and an opposite interior surface. A child-appealing graphic image is disposed on a first portion of the visible exterior surface. A plurality of light emitting diodes are attached to this portion at predetermined locations on the graphic image. A printed circuit board is disposed between the first portion of the visible exterior surface and the opposite interior surface. Driver circuitry is provided on the printed circuit board and is configured to cause the light emitting diodes to blink. A battery module is fixedly coupled to the interior surface, and a switch is electrically coupled between the battery module and the printed circuit board for controlling the application of power to the driver circuitry.

### BRIEF DESCRIPTION OF THE DRAWINGS

The following drawings are illustrative of particular embodiments of the invention and therefore do not limit the scope of the invention, but are presented to assist in providing a proper understanding. The drawings are not to scale (unless so stated) and are intended for use in conjunction with the explanations in the following detailed description. The present invention will hereinafter be described in conjunction with the appended drawings, wherein like numerals denote like elements, and:

FIGS. 1 and 2 are perspective and back views of a backpack in accordance with the teachings of the present invention;

FIG. 3 illustrates the backpack of FIGS. 1 and 2 having a battery and switch module attached thereto;

FIG. 4 is an exploded view of a portion of the inventive backpack;

FIG. 5 is a cutaway view of a battery and switch module for use with the inventive backpack;

FIG. 6 is a schematic diagram of the LED circuitry for use with the inventive backpack;

FIG. 7 is a schematic diagram of an LED driver circuit; and

FIGS. 8 and 9 illustrate two alternative graphic designs.

### DETAILED DESCRIPTION OF THE INVENTION

The following description is exemplary in nature and is not intended to limit the scope, applicability, or configuration of the invention in any way. Rather, the following description provides a convenient illustration for implementing exemplary embodiments of the invention. Various changes to the described embodiments may be made in the function and arrangement of the elements described herein without departing from the scope of the invention.

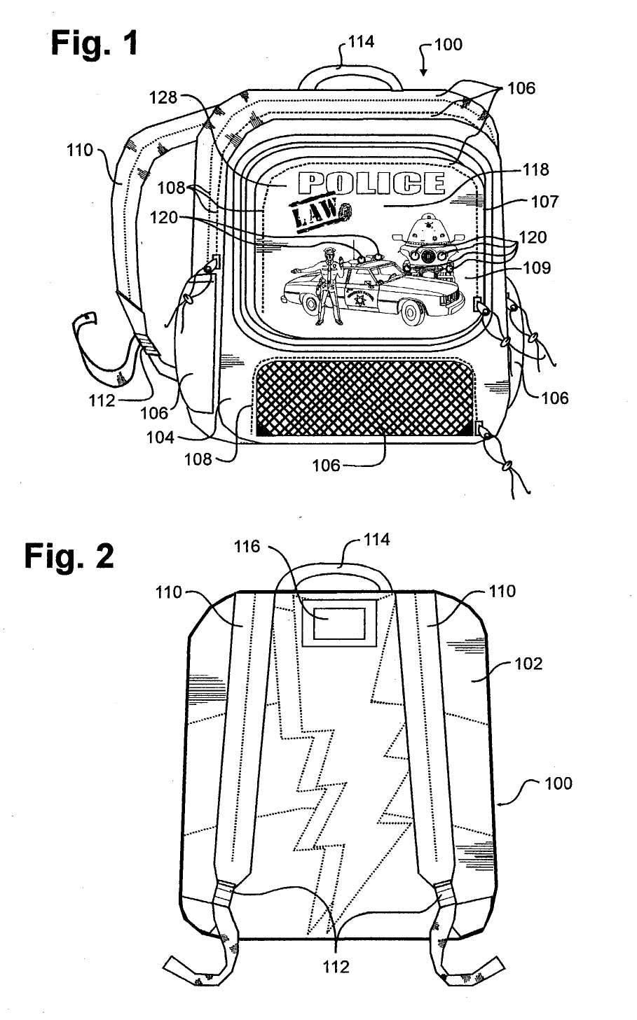

FIGS. 1 and 2 are front perspective and back views of a backpack in accordance with the present invention. While the invention will be described in connection with a backpack, it should be clear that it is equally applicable to other forms of utility packs or carrying cases such as waistpacks, purses, bookbags, etc.

Referring to FIGS. 1 and 2, there is shown a backpack 100 having a back portion 102 and a front portion 104, the front portion being visible from the rear when the backpack is being worn in the traditional manner. The backpack may be made of any suitable material from which backpacks are traditionally made such as canvas, nylon, leather, and the like. As can be seen, the backpack comprises a main body that includes a number of pockets 106, access to which may be achieved by means of, for example, zippers 108 in the well known manner. Backpack 100 may be worn by a child or other user by placing straps 110 over the shoulders and adjusting the straps by means of strap adjustment mechanisms 112. Alternatively, backpack 100 may be carried by means of a handle 114. The backpack may, if desired, be provided with a pocket and/or label 116 for displaying a child's photo and/or other identifying material.

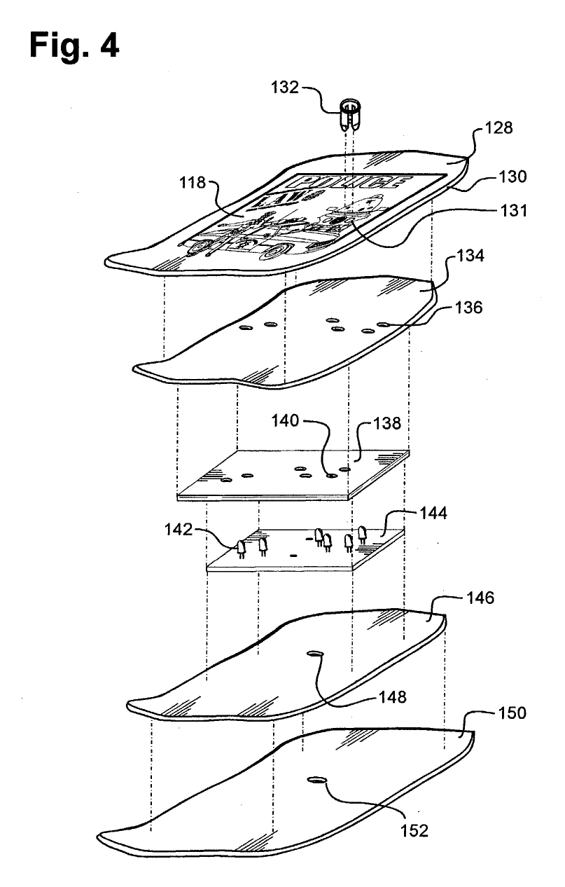

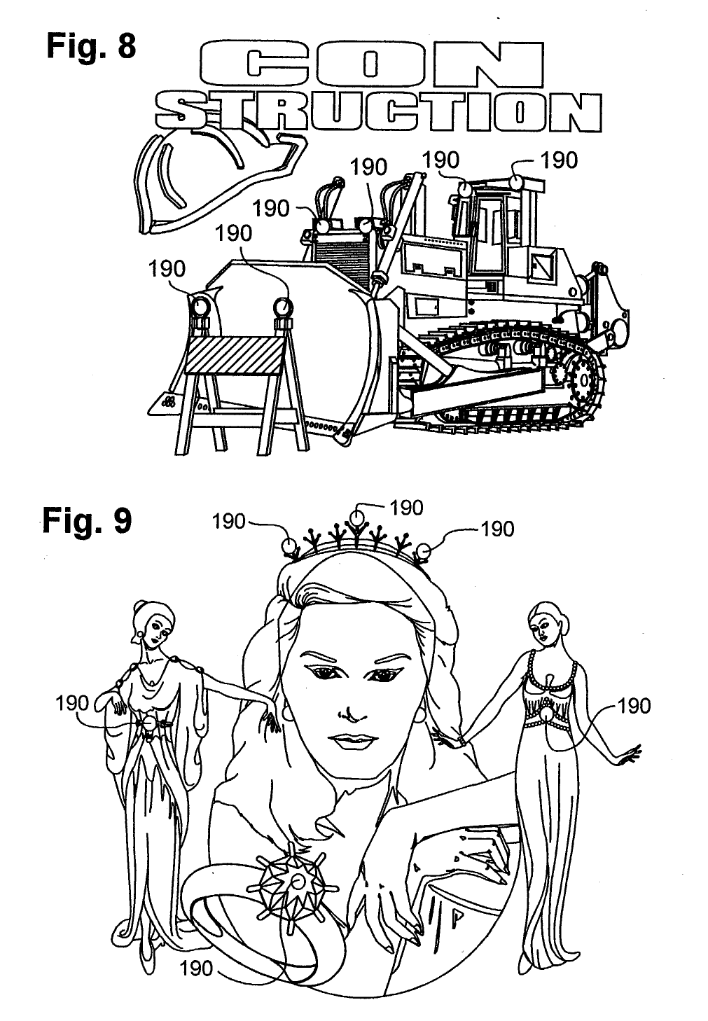

One of the pockets 106 includes a panel 107 having a graphic image or design 118 (preferably reflective) disposed on an exterior or outer visible surface 109 thereof. In the exemplary embodiment, the graphic image includes, among other things, a law enforcement automobile and motorcycle. It should be clear, however, that a large variety of other images may be utilized, two of which are illustrated in FIGS. 8 and 9. Light emitting devices such as light emitting diodes (LEDs) are positioned (as will be discussed below) at predetermined visually complementary locations on the graphic image; e.g. where the vehicles' lights would normally be located, etc. as is shown at 120 in FIG. 1. The process for fixing the LEDs at desired predetermined locations will be described in detail in connection with FIG. 4.

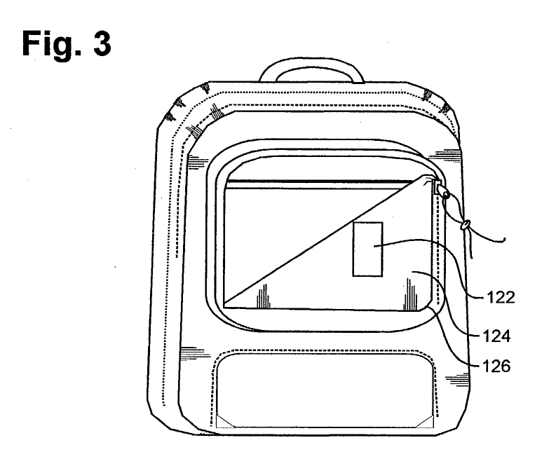

It should be understood that the number, locations, and colors of the LEDs may be chosen to achieve a desired effect. Preferably, the LEDs are extra-brilliant Sunburst Series® blue, green, yellow, red and/or white which are commercially available from Linrose Electronics, Inc., Plainview, N.Y. and which can be seen clearly from a distance of over 150 feet in full daylight. The LEDs are powered by a switch and power module 122 which is mounted or fixed on a normally hidden or interior surface 124 of pocket 126 which displays graphic image 118 on its outer surface (FIG. 3) and as will be described more fully below.

Referring to FIG. 4, graphic image 118 is applied to a first surface of fabric or other material 128 by any suitable method; e.g. heat transferring, silk screening, etc. Holes 131 are then made in the composite graphic/fabric layer 130 at locations where LEDs are desired, and LED clips 132 are attached to composite graphic/fabric 130. The underside of fabric 126 is covered with a waterproof sheet 134 (preferably eight gauge plastic) having holes 136 therein which are smaller than the holes in composite 13 so that the plastic will constrict around the LEDs. A stiffening and shock-absorbing material 138 having holes 140 therein through which LEDs 142 may be press-fit. A printed circuit board 144 having LEDs 142 mounted thereon and containing the appropriate power distribution and driver circuitry (to be discussed below) is then provided and aligned such that LEDs 142 fit through holes 136 and 140 and the holes in graphic/fabric composite 130 so as to engage clips 132. A second piece of waterproof material 146 having a hole 148 therein is then provided. Hole 148 serves to allow wires from switch and battery module 122 to be connected to printed circuit board 144. A second layer of fabric 150 having a hole 152 therein through which wires can pass completes the assembly to which switch and battery module 122 may be attached. Layers 128, 134, and 138 and clips 132 form a composite that is placed over circuit board 142. Clips 132 snap into place over LEDs 142 forming a semi-rigid structure that keeps the LEDs in place and visible regardless of any folds in the backpack.

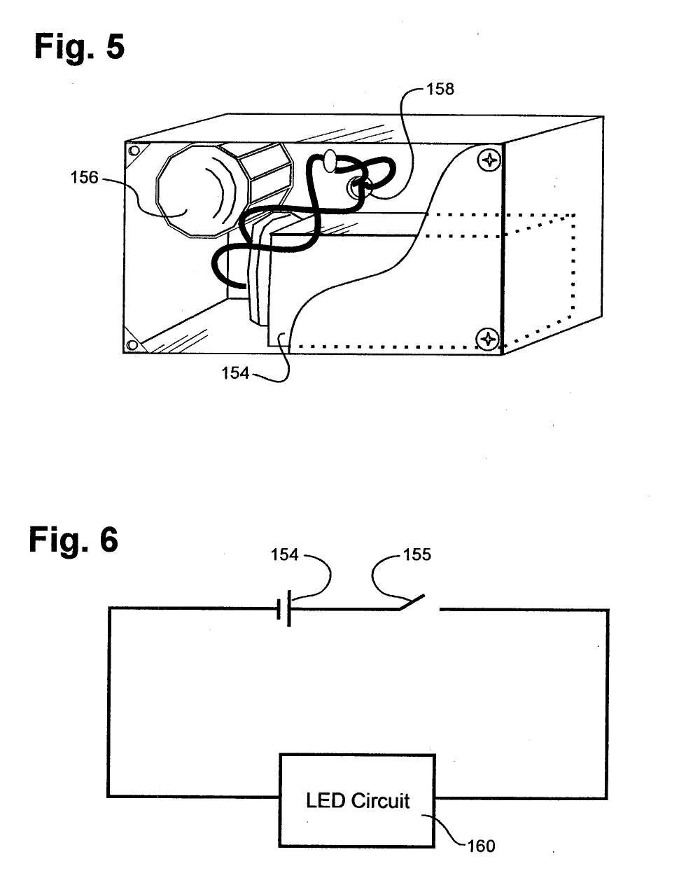

Referring to FIG. 5, power module 122 (FIG. 3) may be made of any material which offers the required stiffness and protection for the components housed therein; e.g. a lightweight durable plastic. Module 122 contains a source of DC power 154; e.g. a nine-volt battery secured by a battery clip (not shown). Also housed within module 122 is a switch 156 (e.g. a mercury-free tilt, motion, or vibration switch) electrically coupled to power source 154. Hole 158 is provided in a rear wall ( i.e. the wall that is secured to layer 150 shown in FIG.4 to permit wires from the interior of module 122 to electrically communicate with printed circuit board 144 (FIG.4). The resulting circuit is shown in FIG. 6 where it can be seen that switch 156, battery 154, and LED circuit 160 (comprised of printed circuit board 144 and LEDs 142) form a series circuit configured to apply power and energize LED circuit 160 when switch 156 is closed.

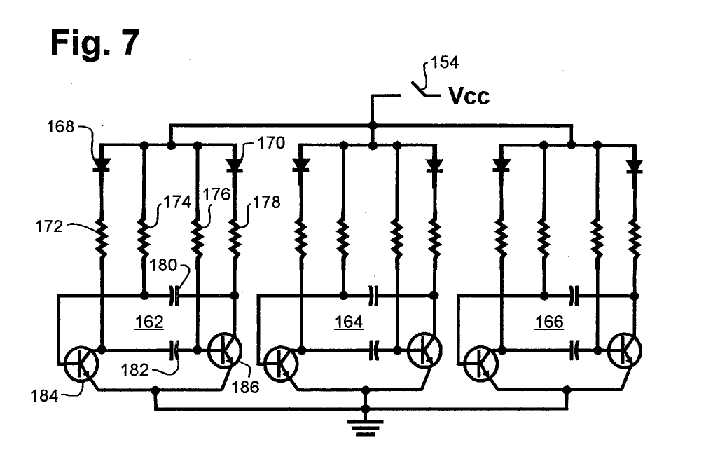

FIG. 7 is a schematic diagram of a blinking LED circuit suitable for implementation on printed circuit board 144. It comprises three identical LED driver circuits 162, 164, and 166. For the sake of simplicity, only the structure and operation of driver circuit 162 will be discussed. When switch 154 is closed, Vcc is applied to the anodes of LEDs 168 and 170 and to first terminals of resistors 174 and 176. The cathode of LED 168 is coupled to the collector of transistor 184 and to a first terminal of capacitor 182 via resistor 172. The cathode of LED 170 is coupled to the collector of transistor 186 and to a first terminal of capacitor 180. A second terminal of capacitor 180 is coupled to the base of transistor 184, and a second terminal of capacitor 182 is coupled to the base of transistor 186. The emitter of transistors 184 and 186 are coupled together and to a second source of supply; e.g. ground.

The circuit operates as follows. Assume first that transistor 184 is saturated and that transistor 186 is off. All current flows through transistor 184 since transistor 184 offers substantially no resistance to current flow. Thus, LED 168 is on. Capacitor 182 charges at a rate which depends only on the time constant of resistor 176 and capacitor 182. The right hand terminal of capacitor 182 is coupled to the base of transistor 186 which is currently off. As the right hand terminal of capacitor 182 becomes increasingly negative, the base of transistor 186 also becomes negative. When the base of transistor 186 becomes sufficiently negative, transistor 186 will be begin to conduct. After a certain period of time, the base of transistor 186 becomes sufficiently negative to cause transistor 186 to turn on, turning LED 170 on. The time necessary for transistor 186 to become saturated is determined by the time constant of resistor 176 and capacitor 182. Thus, the negative voltage accumulated on the right side terminal of capacitor 182 has caused transistor 186 to conduct. Transistor 186 quickly saturates causing the voltage at its collector to fall. Since the collector voltage of transistor 186 is coupled through capacitor 180 to the base of transistor 184, transistor 184 turns off. Now, transistor 184 is off, and transistor 186 is in saturation. The left terminal of capacitor 180 becomes more negative at a rate determined by the time constant of resistor 174 and capacitor 180. As the left side of capacitor 180 becomes more negative, the base of transistor 184 also becomes more negative. When the base of transistor 184 becomes sufficiently negative, transistor 184 will begin to conduct and will go into saturation. The result of the change in voltage at the collector of transistor 184 will cause transistor 186 to turn off. Thus, LEDs will alternately be turned on and off resulting in a blinking effect.

Thus, there has been provided a safety-lighting backpack that is highly visible (over 150 feet) during both daylight and evening hours. It is sturdy, durable, and is equipped with a permanently attached, multicolored, safety-lighting system that is appealing to children and does not require them to remember to turn it “on” when safety lighting is needed. The device is light-weight, water resistant during inclement weather, free of mercury and lead, safe to operate, and difficult to detach or loose.

Although the invention has been described with reference to an illustrative embodiment, it is not intended that the invention be limited to this embodiment. Those of skill in the art will recognize that many variations and modifications exist that do not depart from the true spirit of the invention. For example, while the invention has been described with reference to a backpack, the invention is not to be limited thereto. Rather the invention is applicable to a broad range of carrying cases such as waistpacks, bookbags, etc. Accordingly, it is intended to include within the invention all such variations and modifications as fall within the scope of the appended claims.

1. A carrying case, comprising:
a first panel having a first normally visible surface and a second normally hidden surface opposite said first normally visible surface;
a graphic image disposed on said first normally visible surface of said carrying case; and
a plurality of light emitting devices each attached to said first normally visible surface at predetermined locations on said graphic image.

2. A carrying case according to claim 1 wherein said light emitting devices are light emitting diodes.

3. A carrying case according to claim 2 further comprising a printed circuit board located intermediate said first surface and said second surface to which said light emitting diodes are electrically coupled.

4. A carrying case according to claim 3 further comprising a power module fixedly coupled to said second surface and electrically coupled to said printed circuit board for energizing said light emitting diodes.

5. A carrying case according to claim 4 further comprising a switch electrically coupled between said power module and said printed circuit board for controlling the application of power to said printed circuit board.

6. A carrying case according to claim 5 wherein said power module comprises a battery.

7. A carrying case according to claim 5 wherein said switch is a tilt switch.

8. A carrying case according to claim 5 wherein said switch is a motion switch.

9. A carrying case according to claim 5 wherein said first surface has a first plurality of holes therein, each of said first plurality of holes located at one of said predetermined locations for receiving one of said light emitting diodes therethrough.

10. A carrying case according to claim 9 further comprising a first layer of waterproof material disposed between said first surface and said printed circuit board.

11. A carrying case according to claim 10 further comprising a second layer of waterproof material disposed between said second surface and said printed circuit board.

12. A carrying case according to claim 11 wherein said first and second layers are plastic.

13. A carrying case according to claim 9 wherein said carrying case is a backpack.

14. A carrying case according to claim 9 further comprising driver circuitry on said printed circuit board for causing said plurality of light emitting diodes to blink.

15. A carrying case of the type which includes at least one enclosure, at least a section of which includes a visible exterior surface and an opposite interior surface, said backpack comprising;
a graphic image disposed on said exterior surface of said carrying case; and
a plurality of light emitting diodes each attached to said exterior surface at predetermined locations on said graphic image.

16. A carrying case according to claim 15 further comprising:
a printed circuit board located intermediate said interior surface and said exterior surface to which said light emitting diodes are electrically coupled; and
driver circuitry on said printed circuit board for causing said plurality of light emitting diodes to blink.

17. A carrying case according to claim 16 further comprising a power module fixedly coupled to said interior surface and electrically coupled to said printed circuit board for energizing said light emitting diodes.

18. A carrying case according to claim 17 further comprising a switch electrically coupled between said power module and said printed circuit board for controlling the application of power to said printed circuit board.

19. A carrying case according to claim 18 wherein said carrying case is a backpack.

20. A safety backpack of the type that includes at least one enclosure having a visible exterior surface and an opposite interior surface, said safety backpack comprising:
a child-appealing graphic image exposed on at least a first portion of said visible exterior surface;
a plurality of light emitting diodes attached to said first portion at predetermined locations on said graphic image;
a printed circuit board disposed intermediate said first portion of said visible exterior surface and said opposite interior surface;
driver circuitry on said printed circuit board electrically coupled to said light emitting diodes and configured to cause said light emitting diodes to blink;
a battery module fixedly coupled to said interior surface and electrically coupled to said printed circuit board; and
a switch electrically coupled between said battery module and said printed circuit board for controlling the application of power to said driver circuitry.
